(19) United States
(12) Patent Application Publication
(10) Pub. No.: US 2025/0346066 A1
(43) Pub. Date: Nov. 13, 2025

(54) CHALK BOX WITH A FLEXIBLE TIP

(71) Applicant: OX TOOLS GLOBAL INVESTMENTS LTD, Orpington (GB)

(72) Inventor: Avril GRIESSBACH, Rochester, NY (US)

(21) Appl. No.: 19/204,436

(22) Filed: May 9, 2025

Related U.S. Application Data
(60) Provisional application No. 63/645,767, filed on May 10, 2024.

(51) Int. Cl. B44D 3/38

(52) U.S. Cl. CPC B44D 3/38

(57) ABSTRACT

A chalk box having a housing that includes a spool mounted within the housing for rotation with respect to the housing. A line is wound upon the spool and a crank is mounted to the spool to rotate the spool with respect to the housing. The housing has an exit opening and a flexible tip mounted adjacent the opening. The flexible tip has a hole in communication with the exit opening. The flexible tip is adapted to be squeezed to reduce the diameter of the hole. The flexible tip is adapted to hold the line when the flexible tip is squeezed. The line can be retracted into the housing when the crank is turned and the spool is rotated.

### CROSS-REFERENCE TO RELATED APPLICATIONS

This application claims the benefit of U.S. Provisional Application Ser. No. 63/645,767 filed on May 10, 2024, which is incorporated herein by reference in its entirety.

### TECHNICAL FIELD

This invention relates generally to chalk boxes and more specifically to a chalk box with a unique tip that reduces or eliminates chalk on the users fingers, produces more accurate chalk lines, and reduces or eliminates chalk spilling.

### BACKGROUND OF THE INVENTION

A chalk box (also called a chalk reel or snap line) is a tool used in construction and carpentry to create long, straight, temporary lines on flat surfaces. Inside the box is a string that runs through chalk powder; when pulled taut and snapped against a surface, it leaves a crisp, visible line that serves as a guide for cutting, framing, laying tile, and other detailed tasks.

The box often includes a handle to retract the string, and some even have fill ports for adding chalk or windows to check the level. Common chalk colors include blue, red, black, and white—each suited for different surfaces and permanence levels.

The chalk box solves a very practical problem: how to transfer plans and measurements onto real-world materials quickly and accurately. The key benefits of a chalk box are:
Speed and Efficiency: Allows for fast, accurate layout work, especially for long distances.
Versatility: Can be used on wood, concrete, drywall, and other surfaces.
Portability: Small, lightweight, and easy to carry on any job site.
Precision: Ensures straight cuts, alignments, and installations.
Cost-Effective: A durable tool with inexpensive refills, making it ideal for repeated use.
   Chalk boxes are essential for tradespeople who need reliable reference lines to guide cutting, building, or aligning materials with accuracy and minimal effort.

Chalk boxes have been known for years. Known chalk boxes have several problems. The line or string has to be held at both ends to get an accurate line. Known chalk boxes do not provide a secure holding mechanism at the exit hole of the chalk box. The user normally has to hold the line near the chalk box to see the line and get proper alignment. This creates the problem of inaccuracy and results in chalk getting on the user's hands. This is another problem with known chalk boxes. Another problem is chalk spillage from the chalk box at the string exit opening.

It is desirable to reduce or eliminate chalk on the users' fingers, produce more accurate chalk lines, and reduce or eliminate chalk spilling.

### SUMMARY OF THE INVENTION

In general terms, this invention provides a chalk box having a housing that includes a spool mounted within the housing for rotation with respect to the housing. A line is wound around the spool, and a crank is mounted to the spool to rotate the spool with respect to the housing. The housing has an exit opening and a flexible tip mounted adjacent the opening. The flexible tip has a hole in communication with the exit opening. The flexible tip is adapted to be squeezed to reduce the diameter of the hole. The flexible tip is adapted to hold the line when the flexible tip is squeezed. The line can be retracted into the housing when the crank is turned and the spool is rotated.

In the disclosed embodiment, the flexible tip has a base mounted to the housing. The hole extends through the base, and two fingers extend from said base. The line extends between the fingers, with the fingers being adapted to grip the line when squeezed. The two fingers have facing surfaces between which the line extends. The facing surfaces can include serrations to grip the line.

### BRIEF DESCRIPTION OF THE DRAWINGS

FIG. 1 is a perspective view of the chalk box of the present invention.

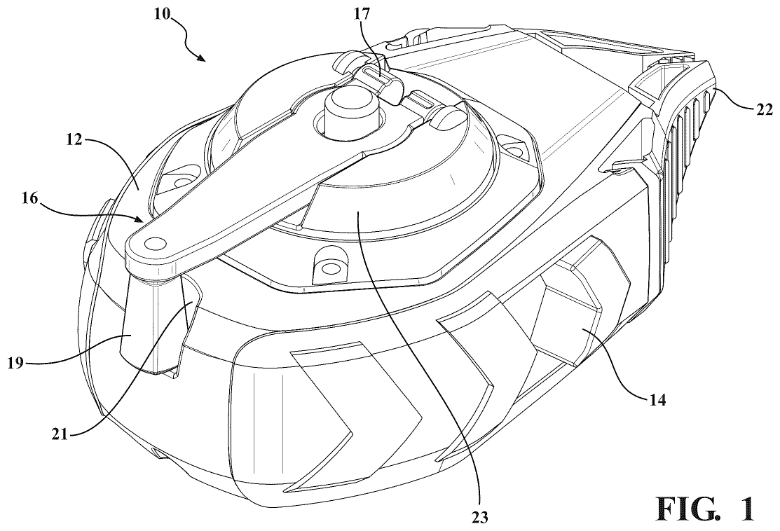

FIG. 2 is a side view of the chalk box in use.

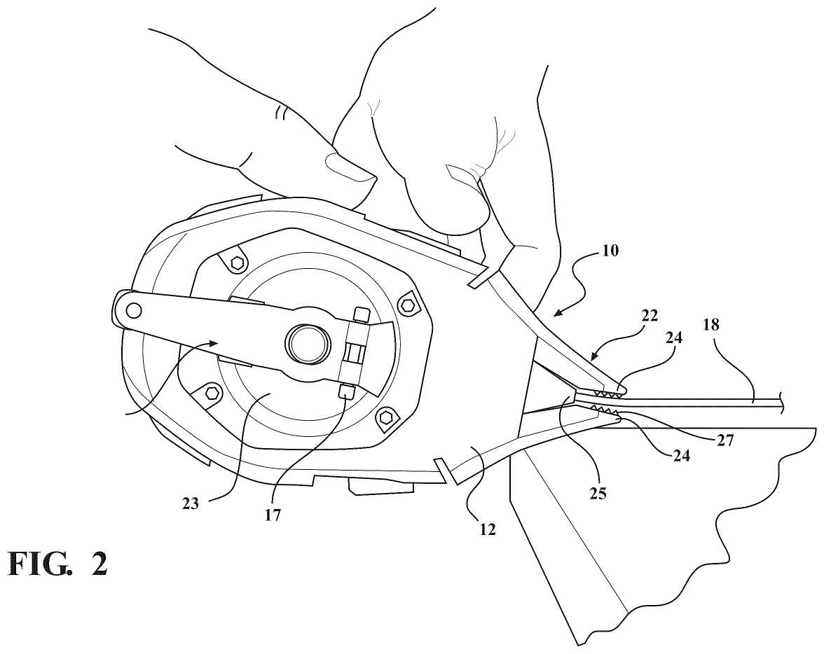

FIG. 3 is a side view of the chalk box in use.

FIG. 4 is a top view of the chalk box.

FIG. 5 is an exploded view of the chalk box.

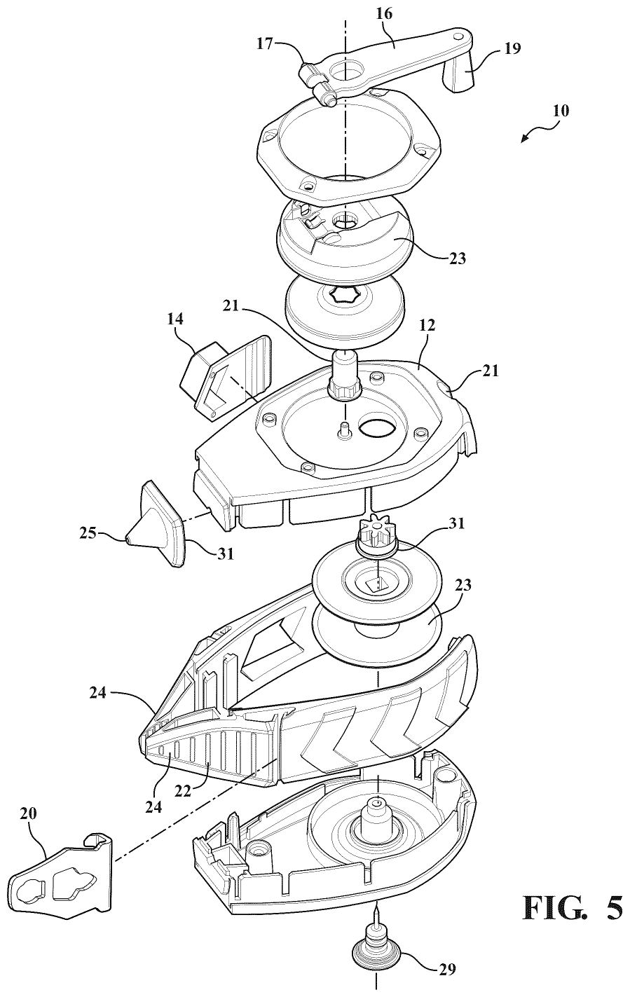

### DETAILED DESCRIPTION OF A PREFERRED EMBODIMENT

The chalk or reel box of the present invention is shown generally at 10. The chalk box includes a box or housing 12. The box 12 holds chalk which can be added to the box 12 through a chalk door 14. The chalk door 14 can be any closure that can be opened to add chalk, for example a hinge door, a sliding door, a slitted opening that opens when forced, etc.

A crank 16 is mounted for rotation with respect to the box 12. As illustrated, the crank 16 is hinged at 17 so that it can be moved from the stored position as illustrated to a cranking position in which the crank 16 is at an angle to the stored position. The crank 16 includes a knob 19 connected to the free end of the crank 16. The knob 19 is received within a recess 21 to lock the crank 16 in the stored position.

The crank 16 is operatively connected to a spool 23 mounted for rotation with respect the box 12. The spool 23 extends into the cavity of box 12. A gear 21 is mounted to handle 16 and engages gear 31 is mounted to rotate the spool 23. The spool 23 is mounted on a journal shaft 29. A chalk line 18 is connected to the spool 23. The chalk line 18 is wound around the spool 23 when the crank 16 is turned. The chalk line 18 is unwound from the spool 23 when it is pulled from the box 12. The cavity of the box 12 contains chalk which covers the line 18 to create a line that can transfer chalk to another surface to mark that surface. A hook 20 can be attached to the free end of the chalk line 18 to keep the line from being fully rewound into the box 12. The hook 20 also provides an attachment for attaching the line 18.

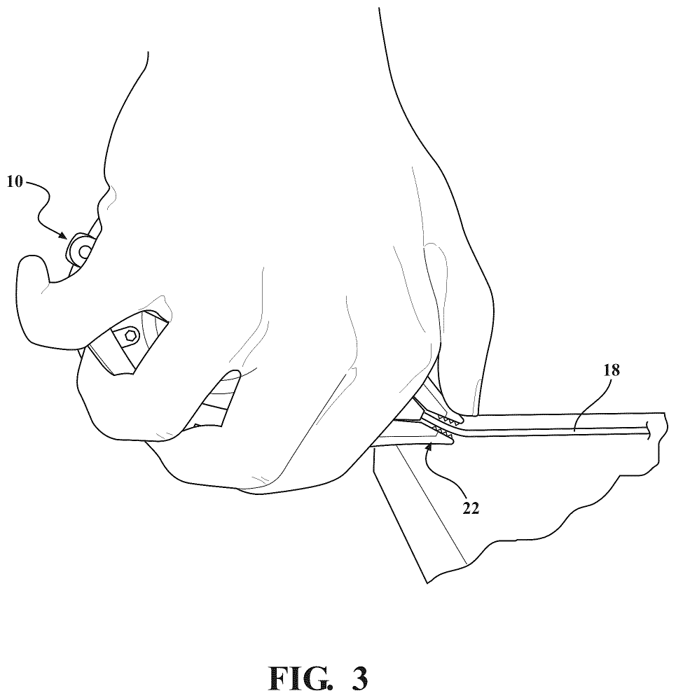

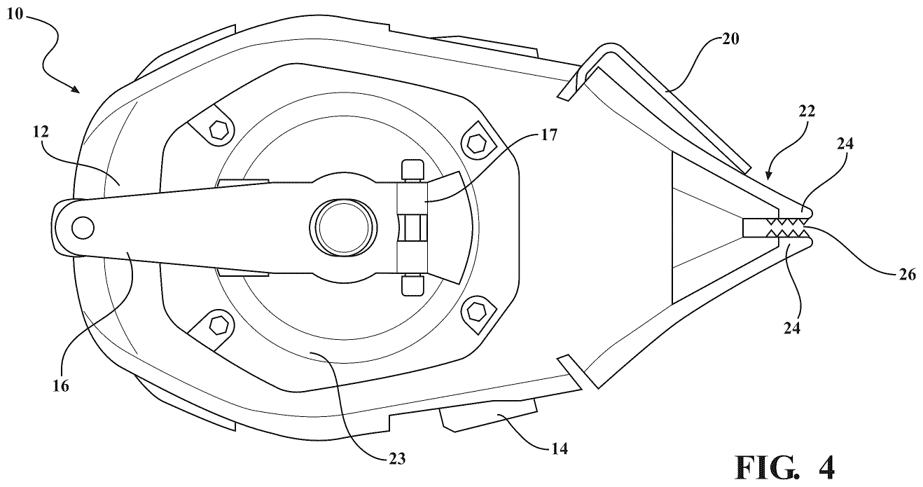

The line 18 exits the box 12 through a small exit opening 25 in a chalk catching cavity 31. A tip 22 is mounted adjacent to the opening 25. The tip 22 has two opposed fingers 24 that define a hole or opening 27. In the disclosed embodiment, the fingers 24 have optional serrated edges 26. The line 18 extends between the fingers 24. As shown in FIGS. 3 and 4, the fingers 24 are flexible and can be squeezed together to hold the line 18 firmly so that the line 18 can be snapped without the chalk line 18 moving. This insures an accurate line every time. The tip 22 also avoids the user getting chalk on their hands. It also serves as an additional way to prevent chalk from spilling out of the box 12 because of the chalk catching cavity 31 adjacent the small exit opening 25. In the disclosed embodiment, the tip 22 is made of rubber, silicone, or other flexible materials.

In use, the line 18 is hooked onto a work surface by the hook 20. The line 18 is then extended. Once the line 18 is fully extended, the tip 22 is pressed against the work surface as shown in FIG. 3. The compressed fingers 24 grip and hold the line 18 without chalk getting on the users' hands. The fingers 24 also firmly hold the line 18 for a more accurate line. The fingers 24 also hold residual chalk in the cavity of the tip 22. The line can be snapped to create a chalk mark in the work surface. Afterwards, the line 18 is reeled back into the box 12 by crank 16.

These and other features and advantages of this invention will become more apparent to those skilled in the art from the detailed description of a preferred embodiment. The drawings that accompany the detailed description are described below.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

What is claimed is:

1. A chalk box comprising;
a housing;
a spool mounted within said housing for rotation with respect to said housing;
a line spooled upon said spool;
a crank mounted to said spool to rotate said spool with respect to said housing;
an exit opening is said housing;
a flexible tip mounted adjacent said opening, said flexible tip having a hole in communication with said exit opening, said flexible tip is adapted to be squeezed to reduce the diameter of said hole;
said line extending through said exit opening and said hole, said line being adapted to be pulled from said housing through said exit opening and said hole, said flexible tip being adapted to hold said line when said flexible tip is squeezed, said line being adapted to retract into said housing when said crank is turned and said spool is rotated.

2. The chalk box of claim 1, further including a hook attached to said line to prevent the end of said line from fully retracting into said housing and to allow said line to be hooked to a work surface.

3. The chalk box of claim 1, further including an access opening for filling said housing with chalk.

4. The chalk box of claim 1, further including a closure for closing said access opening.

5. The chalk box of claim 1, wherein said crank includes a hinge, said hinge attaches said crank to said spool, said crank is adapted to be moved from a stored position to a use position about said hinge.

6. The chalk box of claim 5, wherein said crank includes a rotatable knob to facilitate cranking.

7. The chalk box of claim 6, where said housing includes a recess for receipt of said knob in said stored position.

8. The chalk box of claim 1, wherein said flexible tip has a base mounted to said housing, said hole extends through said base.

9. The chalk box of claim 8, including two fingers extending from said base, with said line extending between said fingers, said fingers being adapted to grip said line when squeezed.

10. The chalk box of claim 9, wherein said two fingers have facing surfaces between which said line extends.

11. The chalk box of claim 10, wherein said facing surfaces include serrations to grip said line.
